(19) United States
(12) Patent Application Publication
(10) Pub. No.: US 2010/0309608 A1
(43) Pub. Date: Dec. 9, 2010

(54) Buried Capacitor Structure

(76) Inventors: Chien-Wei Chang, Taoyuan (TW); Ting-Hao Lin, Taipei (TW); Ya-Hsiang Chen, Yun-Lin (TW); Yu-Te Lu, Taoyuan (TW)

Correspondence Address: LIN & ASSOCIATES INTELLECTUAL PROPERTY, INC., P.O. BOX 2339, SARATOGA, CA, 95070-0339, US

(21) Appl. No.: 12/479,810

(22) Filed: Jun. 7, 2009

(51) Int. Cl. H01M 6/14

(52) U.S. Cl. 361/526

(57) ABSTRACT

A buried capacitor structure including a first conductive metal layer, a first dielectric film, a capacitor, a second dielectric film, and a second conductive metal layer, which are stacked in sequence, wherein the capacitor is buried between the first dielectric film and the second dielectric film, the first conductive metal layer is formed into a first circuit pattern, the second conductive metal layer is formed into a second circuit pattern. The capacitor is a planar comb-shaped capacitor with a positive electrode, a negative electrode, and a capacitor paste filled between the positive electrode and the negative electrode, wherein the positive electrode includes a positive electrode end and a plurality of positive comb branches, the negative electrode includes a negative electrode end and a plurality of negative comb branches, and the positive branches and the negative branches are parallel to and separated from each other.

### BACKGROUND OF THE INVENTION

1. Field of the Invention

The present invention generally relates to a buried capacitor structure, and more particularly to a circuit board having a capacitor buried therein.

2. The Prior Arts

Buried passives are passive components disposed between layers of a multi-layer circuit board. The electronic components, such as capacitors or resistors are directly formed on an inner layer of the circuit board by etching or printing. Then, at least one outer layer of the circuit board is laminated onto the inner circuit board to bury the electronic component inside the multi-layer circuit board. The buried passives are adapted to replace those discrete passives soldered to the circuit board, so as to free up space on the circuit board to pack more circuitry and active components.

Buried resistor technologies are first proposed by Ohmega Technologies, Inc., a manufacturer of OHMEGA-PLY® resistor-conductor material. The buried resistor is a thin film of a phosphorous-nickel alloy serving as a resistive element plated onto a matt side of a copper foil of an inner layer. Then, they are compressed to configure a thin core, and later processed by photo-resist processing twice and etching processing thrice, so as to configure a desired thin film resistor at a specific position. Such a thin film resistor is disposed between the layers, and thus called buried resistor.

Generally, a conventional capacitor structure includes a parallel plate capacitor, which has a source electrode and a ground electrode divided by a dielectric layer. Various approaches have been used to increase capacitance of the capacitor. One of the solutions is to provide the dielectric layer with a higher permittivity. Capacitance of the capacitor increases with area and decreases with separation. Thus, another solution is to increase the area of the source electrode and ground electrode, and to decrease the distance between the source electrode and the ground electrode.

However, these solutions introduce other problems. On the one hand, the source electrode is disposed very close to the ground electrode to increase capacitance. Thus, when layers of the circuit board are laminated, the source electrode or the ground electrode is prone to be pressed into the dielectric layer. It even makes the source electrode to contact with the ground electrode, which causes short circuit. On the other hand, the large area of the source electrode and ground electrode increase the thickness of the entire capacitor structure.

To overcome the disadvantages mentioned above, a capacitor is embedded into a dielectric film by a pressing process. Moreover, the parallel plate capacitor is replaced by a comb-type capacitor, which has two comb shapes facing each other and interleaving their branches without touching. Therefore the distance between branches is narrower the distance between the electrodes.

FIG. 1 is a schematic view showing a conventional buried capacitor structure. Referring to FIG. 1, a conductive metal layer 30 is deposited on a first surface of a dielectric film 20 and patterned to form a circuit pattern. A capacitor 10 is pressed to be buried in a second surface of the dielectric film 20, wherein the capacitor 10 is a comb-type capacitor with a comb-shaped positive electrode plate and a comb-shaped negative electrode plate.

In the above-described configuration, parts of the comb-shaped positive electrode plate and the comb-shaped negative electrode plate are exposed on the second surface of the dielectric film 20, and thus electrical property of the capacitor is affected by environmental factors. For example, high humidity can reduce breakdown voltage of the capacitor, and even damage the capacitor.

### SUMMARY OF THE INVENTION

A primary objective of the present invention is to provide a buried capacitor structure, which overcomes the disadvantages of the conventional design. The buried capacitor structure according to the present invention is insulated from the environment and is not affected by environmental factors, and in the meanwhile has high capacitance.

The solution of the present invention is to provide a buried capacitor structure including a first conductive metal layer, a first dielectric film, a capacitor, a second dielectric film, and a second conductive metal layer, which are stacked in sequence. Wherein, the capacitor is buried between the first dielectric film and the second dielectric film. The first conductive metal layer and the second conductive metal layer are formed into a first circuit pattern and a second circuit pattern, respectively. The capacitor has a positive electrode end and a negative electrode end connected with the second conductive metal layer. The capacitor structure is provided with a through-hole to connect the first conductive metal layer with the second conductive metal layer, thereby increasing the reliability of the capacitor and reducing the area of the capacitor.

The capacitor according to the present invention may be a planar comb-shaped capacitor and has a positive electrode and a negative electrode. The positive electrode includes the positive electrode end and a plurality of positive comb branches, and the negative electrode includes the negative electrode end and a plurality of negative comb branches. The positive comb branches and the negative comb branches face each other and interleave without touching. The interleaving positive comb branches and the negative comb branches are disposed at the same plane, parallel to each other, and keep a same separation distance therebetween. Moreover, a capacitor paste is filled between the positive comb branches and the negative comb branches, thereby improving insulation and raising breaking voltage. Therefore, the capacitance of the buried capacitor structure is increased.

The buried capacitor structure according to the present invention includes a comb-type capacitor to increase capacitance. Further, the capacitor is buried in the dielectric films for being insulated from the environment, and thus is not affected by the environmental factors.

### BRIEF DESCRIPTION OF THE DRAWING

The present invention will be apparent to those skilled in the art by reading the following detailed description of a preferred embodiment thereof, with reference to the attached drawings, in which:

FIG. 1 is a schematic view showing a conventional buried capacitor structure;

FIG. 2 is a schematic view showing a buried capacitor structure according to the present invention; and

FIG. 3 is a schematic view showing a capacitor in the buried capacitor structure in FIG. 2.

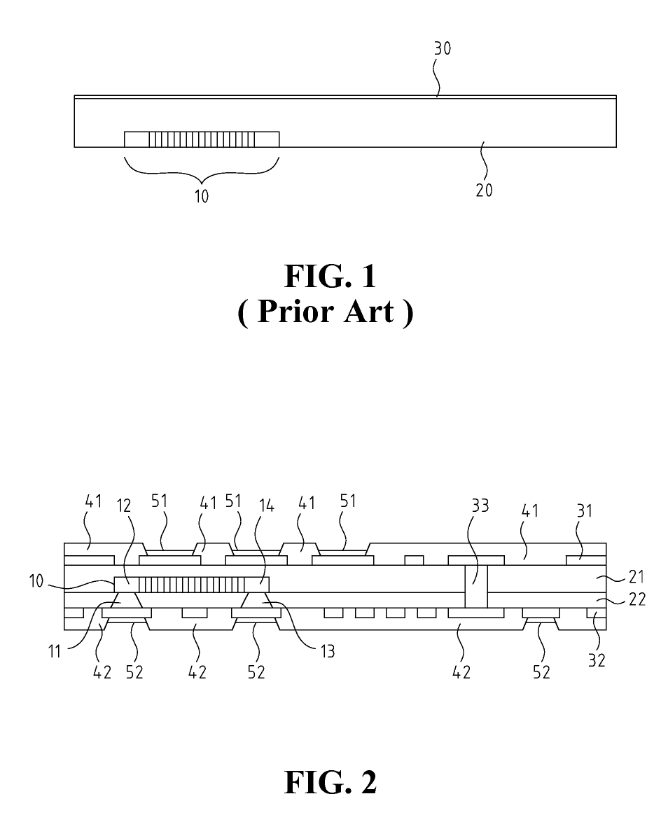

### DETAILED DESCRIPTION OF THE PREFERRED EMBODIMENT

FIG. 2 is a schematic view showing a buried capacitor structure according to an embodiment of the present invention. Referring to FIG. 2, the buried capacitor structure includes a capacitor 10, a first dielectric film 21, a first conductive metal layer 31, a second dielectric film 22, a second conductive metal layer 32, a first insulating layer 41, a third conductive metal layer 51, a second insulating layer 42 and a fourth conductive metal layer 52. The capacitor 10 is buried between the first dielectric film 21 and the second dielectric film 22. The first conductive metal layer 31 is deposited on the first dielectric film 21 and patterned to form a first circuit pattern, and the second conductive metal layer 32 is deposited on the second dielectric film 22 and patterned to form a second circuit pattern. Furthermore, a through-hole 33 is defined through the first dielectric film 21 and the second dielectric film 22, and is filled with conductive metal to electrically connect the first conductive metal layer 31 to the second conductive metal layer 32.

The capacitor 10 has a positive electrode end 12 and a negative electrode end 14. A positive lead 11 electrically connects the positive electrode end 12 with the second conductive metal layer 32, and a negative lead 13 electrically connects the negative electrode end 14 with the second conductive metal layer 32. The positive lead 11 and the negative lead 13 are formed by filling conductive metal into a positive through-hole and a negative through-hole of the second dielectric film 22, respective.

The first insulating layer 41 is deposited to cover the patterned first conductive metal layer 31 and the exposed first dielectric film 21, and then a plurality of openings are formed therein to expose a portion of the first conductive metal layer 31. Similarly, the second insulating layer 42 is deposited to cover the patterned second conductive metal layer 32 and the exposed second dielectric film 22, and then several openings are formed therein to expose a portion of the second conductive metal layer 32. The first insulating layer 41 and the second insulating layer 42 provide electrical insulation, and may be made of conventional insulating green paint for printed circuit board. The third conductive metal layer 51 is deposited on the openings of the first insulating layer 41, and the fourth conductive metal layer 52 is deposited on the openings of the second insulating layer 42. The third conductive metal layer 51 and the fourth conductive metal layer 52 serves as soldering layers for soldering other electronic components, such as resistors, capacitors, inductors, etc.

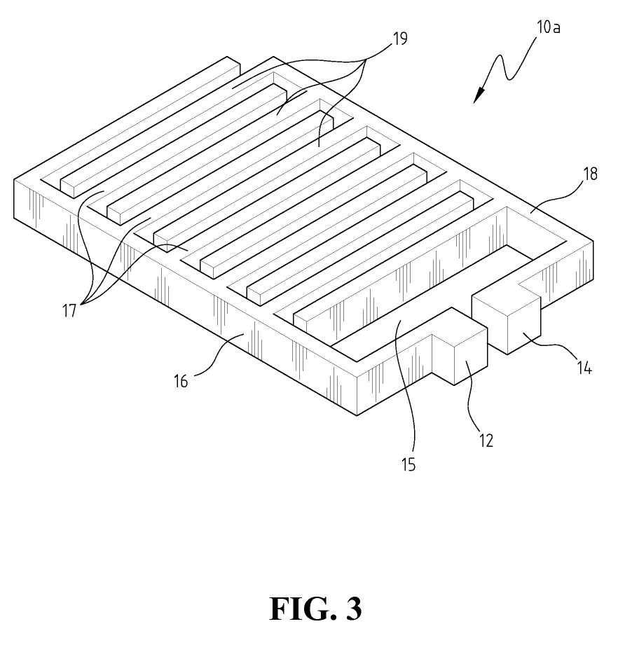

Referring to FIG. 3, the capacitor 10 of the buried capacitor structure according to the present invention can be, but not limited to, a planar comb-type capacitor 10a. The planar comb-type capacitor 10a includes a positive electrode 16 and a negative electrode 18. The positive electrode 16 includes a positive electrode end 12 and a plurality of positive comb branches 17, and the negative electrode 18 includes a negative electrode end 14 and a plurality of negative comb branches 19. The positive comb branches 17 and the negative comb branches 19 face each other and interleave without touching. A clearance between the positive electrode 16 and the negative electrode 18 is filled with a capacitor paste 15 for preventing a short circuit between the positive electrode 16 and the negative electrode 18. The capacitor paste 15 also increases the capacitance of the planar comb-shaped capacitor 10a in a limited space.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A buried capacitor structure, comprising:
a first dielectric film having a first surface and a second surface;
a capacitor pressed into the second surface of the first dielectric film, the capacitor including a positive electrode, a negative electrode, and a capacitor paste filled between the positive electrode and the negative electrode, wherein the capacitor paste separates the positive electrode from the negative electrode, the positive electrode has a positive electrode end, and the negative electrode has a negative electrode end;
a second dielectric film having a first surface and a second surface, the second surface of the second dielectric film in contract with the second surface of the first dielectric film, wherein a positive through-hole and a negative through-hole are defined through the second dielectric film and corresponding to the positive electrode end and the negative electrode end of the capacitor, respectively;
a first conductive metal layer deposited on the first surface of the first dielectric film and patterned to form a first circuit pattern; and
a second conductive metal layer deposited on the first surface of the second dielectric film and patterned to form a second circuit pattern;
wherein the positive through-hole and the negative through-hole are filled with a conductive metal to form a positive lead and a negative lead, respectively;
the positive lead and the negative lead electrically connect the positive electrode end and the negative electrode end with the second conductive metal layer, respectively.

2. The buried capacitor structure as claimed in claim 1, further comprising:
a first insulating layer covering the first conductive metal layer, wherein a plurality of openings are defined in the first insulating layer to expose a portion of the first conductive metal layer;
a second insulating layer covering the second conductive metal layer, wherein a plurality of openings are defined in the second insulating layer to expose a portion of the second conductive metal layer;
a third conductive metal layer deposited on the openings of the first insulating layer; and
a fourth conductive metal layer deposited on the openings of the second insulating layer.

3. The buried capacitor structure as claimed in claim 1, wherein the positive electrode of the capacitor further comprises a plurality of positive comb branches, and the negative electrode of capacitor further comprises a plurality of negative comb branches.

4. The buried capacitor structure as claimed in claim 3, wherein the positive comb branches and the negative comb branches interleave with each other, and the positive comb branches and the negative comb branches are parallel to and separated from each other with a predetermined distance.

5. The buried capacitor structure as claimed in claim 3, wherein the capacitor paste is made of an insulating material.
